(19) United States
(12) Patent Application Publication
(10) Pub. No.: US 2024/0328883 A1
(43) Pub. Date: Oct. 3, 2024

(54) PROTECTIVE COVER AND MEASURING UNIT COMPRISING A PROTECTIVE COVER

(71) Applicant: VEGA Grieshaber KG, Wolfach (DE)

(72) Inventors: Joern JACOB, Wolfach (DE); Thomas KOPP, Wolfach (DE); Martin MELLERT, Steinach (DE); Jochen HUBER, Wolfach (DE); Maximilian HAAS, Aichhalden (DE)

(73) Assignee: VEGA Grieshaber KG, Wolfach (DE)

(21) Appl. No.: 18/615,705

(22) Filed: Mar. 25, 2024

(30) Foreign Application Priority Data
Mar. 27, 2023 (DE) 10 2023 107 689.2

(51) Int. Cl. G01L 19/06; G01L 19/00

(52) U.S. Cl. CPC G01L 19/0654; G01L 19/0061

(57) ABSTRACT

A protective cover for an electronic device for instance a measuring cell including a ceramic pressure measuring cell, that includes at least one connecting element that provides a data connection, the protective cover having an electrical circuit for instance an application-specific integrated circuit.

### CROSS-REFERENCE TO RELATED APPLICATIONS

This application claims the benefit of the filing date of German Patent Application No. 10 2023 107 689.2 filed on 27 Mar. 2023, the entire content of which is incorporated herein by reference.

### FIELD

The present disclosure relates to a protective cover for an electronic device, for instance a measuring device including a ceramic pressure measuring cell, and a measuring unit, in particular a ceramic pressure measuring cell, with such a protective cover.

### BACKGROUND

In process industry, measuring sensors are used in many different areas. For example, in addition to process or differential pressure, pressure measurement using pressure measuring cells is also used to measure level, volume, density or flow in all areas of process engineering and process measurement technology. Measuring ranges of pressure sensors start at a few mbar—but they may also handle extreme pressures of up to 1,000 bar. Different measuring cells are used for pressure measurement. For example, ceramic pressure measuring cells can be used. Such measuring cells are therefore often used in areas where they can be damaged mechanically or by corrosion.

It has become apparent that there is a need to provide a further protective cover for an electronic device, in particular a pressure measuring cell.

There may be a desire to provide a protective cover for an electronic device, in particular for a ceramic pressure measuring cell.

These and other desires, which will become apparent when reading the following description or which may be recognized by the skilled person, are met by the subject matter of the independent claims. The dependent claims relate to embodiments of the present disclosure.

### SUMMARY

A protective cover for an electronic device, in particular a measuring cell, preferably a ceramic pressure measuring cell, comprising at least one connecting element configured to provide a data connection; wherein the protective cover comprises an electrical circuit, in particular an application-specific integrated circuit.

The protective cover of the present disclosure may be at least partially made of a plastic. The protective cover has the connecting element for passing on data, for example measurement data. The connecting element can, for example, be designed as a plug or a socket.

The protective cover also includes the electrical circuit. The electrical circuit is configured as an application-specific integrated circuit. In other words, the electrical circuit is an Application Specific Integrated Circuit (ASIC). Other types of electrical circuit are also conceivable.

The protective cover according to the present disclosure enables a more compact design, since the electronics or circuitry is arranged in the protective cover. This may make it possible to save costs and material. This may also be advantageous because the space available for mounting the measuring cell can often be limited. The protective cover protects the electrical circuitry or electronics from damage caused by mechanical or chemical influences.

In an embodiment, the connecting element is configured to provide a data connection to the electrical circuit, in particular to the application-specific integrated circuit.

In an embodiment, the protective cover comprises at least partially an electrically conductive area. It may be provided that the protective cover comprises several electrically conductive areas. The electrically conductive area may serve as an earth connection, for example. Furthermore, the electrically conductive area can be designed to protect the electronic circuit from electromagnetic radiation. The electrically conductive area can therefore be designed to improve electromagnetic compatibility (EMC). For this purpose, the electrically conductive area may be configured as a wire mesh, for example.

In an embodiment, the electrically conductive area comprises a metal and/or an electrically conductive plastic. These are easily accessible materials for realizing the electrically conductive area.

In an embodiment, the metal is designed as a sheet metal element. This is another cost-effective way of metallizing the protective cover. It can also increase the stability of the protective cover.

In an embodiment, the conductive area or the conductive areas can be realized by insert elements or inlays made of metal or an electrically conductive plastic.

In an embodiment, the electrically conductive area, in particular the sheet metal element, is grid-shaped. For example, the electrically conductive area can comprise a grid-shaped sheet metal element that is overmolded or encapsulated as an inlay of a plastic part in an injection molding process. This improves the electromagnetic compatibility (EMC).

In an embodiment, the metal comprises nickel or a nickel alloy. Alternatively, other conductive metals or alloys are possible.

In an embodiment, the protective cover is fluid-tight. This protects the electrical circuit and the inside of the measuring cell, on which the protective cover is arranged, from external influences, in particular moisture.

In an embodiment, the protective cover is designed to be bonded with an adhesive, in particular an electrically conductive adhesive.

A further aspect of the present disclosure relates to a measuring unit, in particular a ceramic pressure measuring cell, with a protective cover according to one of the aforementioned embodiments.

### DESCRIPTION OF EMBODIMENTS

A detailed description of the figures is given below:

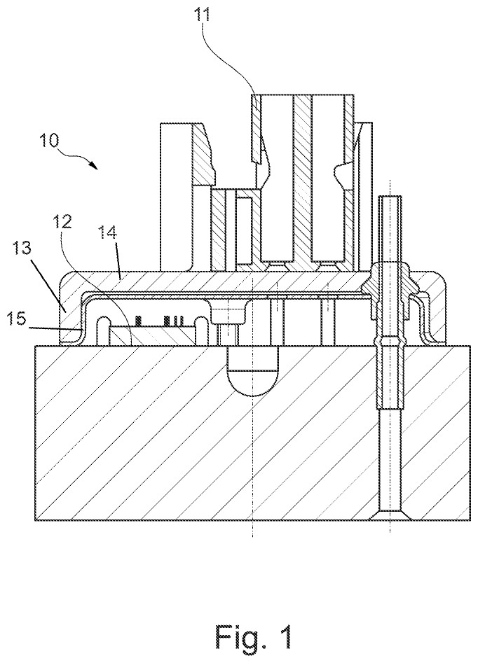

FIG. 1 shows a sectional view of an embodiment of a protective cover; and

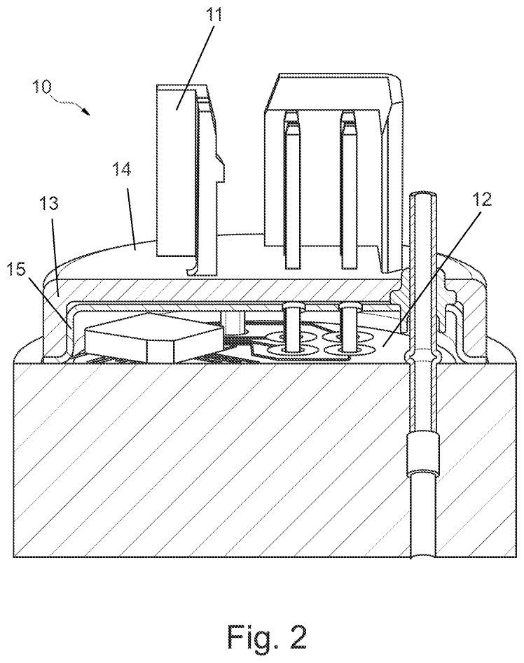

FIG. 2 shows a perspective sectional view of the protective cover as shown in FIG. 1.

FIG. 1 shows a protective cover 10 in the assembled state. In the embodiment example shown in FIG. 1 and FIG. 2, the protective cover is arranged on a measuring cell. Other uses of the protective cover are also conceivable.

The protective cover 10 has an essentially hollow cylindrical geometry, with one axial end being closed. More precisely, the protective cover 10 has a U-shaped geometry in section. The protective cover 10 comprises an annular wall 13, which is closed at one axial end by a circular wall 14. Alternatively, other shapes for the protective cover 10 are conceivable. For example, the protective cover 10 can have a polygonal shape.

A connecting element 11 is arranged on an outer surface in the assembled state. The connecting element 11 is arranged on the circular wall 14, which forms the axial end of the protective cover 10. In the mounted state, the circular wall 14 faces away from the measuring cell on which the protective cover 10 is mounted.

On the inner side in the assembled state, the protective cover 10 has a conductive area 15. In the present embodiment, the conductive area 15 is formed as a metal layer 15. The metal layer 15 is a sheet metal formed on the inside of the protective cover 10. This means that the sheet metal is adapted to the shape of the protective cover 10. The sheet metal has recesses for the pins of the connecting element 11.

The metal layer 15 comprises nickel or a nickel alloy. Alternatively, other metals or alloys or a conductive plastic are possible. The conductive area can have other shapes. For example, it is conceivable that the electrically conductive area comprises a grid structure. It is also conceivable that the conductive area is integrated into the plastic, for example by injection molding.

The connecting element 11 is configured as a plug and comprises four pins. The four pins extend through the protective cover 10 and are connected to an electrical circuit 12, which is designed here as a circuit board. The connecting element 11 is designed to transmit data or electrical signals from the electrical circuit 12.

The protective cover 10 is glued to a measuring cell. Alternatively, other force-fit, form-fit or material-fit connections are possible.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 Protective cover
11 Connecting element
12 Electrical circuit
13 Annular wall
14 Circular wall
15 Conductive area

1. A protective cover for an electronic device, comprising:
at least one connecting element configured to provide a data connection, wherein the protective cover includes an electrical circuit.

2. The protective cover according to claim 1, wherein the at least one connecting element is configured to provide a data connection to the electrical circuit.

3. The protective cover according to claim 1, wherein the protective cover at least partially including a conductive region.

4. The protective cover according to claim 3, wherein the conductive region includes a metal and/or a conductive plastic.

5. The protective cover according to claim 4, wherein the metal is formed as a sheet metal element.

6. The protective cover according to claim 4, wherein the conductive region including a sheet metal element is grid-shaped.

7. The protective cover according to claim 4, wherein the metal includes nickel or a nickel alloy.

8. The protective cover according to claim 1, wherein the protective cover is fluid-tight.

9. The protective cover according to claim 1, wherein the protective cover is configured to be bonded with an adhesive.

10. A measuring device, comprising:
a protective cover for an electronic device including a ceramic pressure measuring cell, comprising:
at least one connecting element configured to provide a data connection, wherein the protective cover includes an electrical circuit including an application-specific integrated circuit.

11. The protective cover according to claim 2, wherein the protective cover at least partially including a conductive region.

12. The protective cover according to claim 5, wherein the conductive region including the sheet metal element is grid-shaped.

13. The protective cover according to claim 5, wherein the metal includes nickel or a nickel alloy.

14. The protective cover according to claim 6, wherein the metal includes nickel or a nickel alloy.

15. The protective cover according to claim 1, wherein the electronic device is a measuring cell.

16. The protective cover according to claim 15, wherein the measuring cell is a ceramic pressure measuring cell.

17. The protective cover according to claim 1, wherein the electrical circuit is an application-specific integrated circuit.

18. The protective cover according to claim 2, wherein the electrical circuit is an application-specific integrated circuit.

19. The protective cover according to claim 9, wherein the adhesive is a conductive adhesive.′

20. The measuring device according to claim 10, wherein the measuring device is a ceramic pressure measuring cell.
